(19) United States
(12) Patent Application Publication
(10) Pub. No.: US 2008/0111338 A1
(43) Pub. Date: May 15, 2008

(54) Indoor Wheelchair

(76) Inventor: Benjamin Ilan, Ramat Gan (IL)

Correspondence Address: NATH & ASSOCIATES, 112 South West Street, Alexandria, VA, 22314, US

(21) Appl. No.: 10/567,111

(22) PCT Filed: Aug. 4, 2004
(86) PCT No.: PCT/IL04/00716

§ 371 Date: Feb. 3, 2006

Related U.S. Application Data
(60) Provisional application No. 60/491,976, filed on Aug. 4, 2003.

(51) Int. Cl. B62M 1/14

(52) U.S. Cl. 280/250.1

(57) ABSTRACT

An indoor wheelchair comprising a carriage with a seat having left, right, front and back edges, a backrest, four carrying wheels and supporting members connecting the seat to the carrying wheels; a left and a right riving mechanism mounted to the carriage, each driving mechanism including a manual driving wheel and a transmission connecting the manual driving wheel to one of the respective left and right carrying wheels, The wheelchair is characterized in that it is free of elements occupying the space under the seat between the innermost surfaces of the driving mechanisms and between the rear carrying wheels so that the wheelchair can be rolled over a common toilet bowl in backward motion, while the overall width of the wheelchair as defined between the outermost surfaces of the driving mechanisms allows passing to the wheel chair through a common bathroom door.

### FIELD OF THE INVENTION

This invention relates to indoor wheelchairs, in particular to self-propelled wheelchairs.

### BACKGROUND OF THE INVENTION

Wheelchairs are a necessity for some handicapped people who are deprived completely or partially of the use of their legs. Indeed wheelchairs are their most important means of moving around and enabling them to be independent to a certain extent. In order to maintain independency, the movement of the wheelchair should be as easy as possible. The following are three distinct categories of propulsion means: (a) Manual propulsion by the handicapped occupant of the wheelchair; (b) Manual propulsion of the wheelchair by a companion; (c) Motorized propulsion of the wheelchair, operated by the occupant of the wheelchair.

Most manual wheelchairs fall in both categories (a) and (b), however, some of the wheelchairs are built especially for one of these categories only.

Another distinction among wheelchairs is between indoor and outdoor use of wheelchairs.

Design for outdoor use addresses the conditions of movement on uneven and sometime steep or rough terrain, putting considerable weight on the stability and traversability. Also in order to facilitate easy transportation by vehicle, most manual wheelchairs are also foldable.

This has led to the development of the popular wheelchair with two big rear manual drive wheels, front caster wheels, and a folding frame. Rings on the big rear wheels allow the occupant to drive and steer the wheelchair. The wheelchair also may be pushed along by a companion using handles mounted on the back.

Most wheelchairs are dual used. However, the requirements of the outdoor use dominate and thus the design of such a dual wheelchair is adapted primary to the more demanding and rigorous outdoor environment. Such a design of a wheelchair is cumbersome for indoor use and poses many problems. Its relative big overall dimensions and maneuvering radius make it difficult and sometimes impossible to drive around corridor corners, through narrow doorways, and into tight places like bathrooms. Alterations in dwellings commanded by such wheelchair are expensive and complicated and in any case, this wheelchair cannot meet all the indoor needs of the handicapped.

In order to overcome such obstacles, smaller wheelchairs, with smaller wheels are designed for indoor use. Most of them are “companion chairs” of the above-mentioned category (b). There also exist self-propelled manual wheelchairs, with intermediate drive mechanisms which allow somewhat smaller floor wheels. Some kinds of motor-propelled wheelchairs are very versatile in indoor use, but they are very expensive and yet not fit for use in bathrooms, toilets etc.

U.S. Pat. No. 4,380,343 discloses a foldable wheelchair having two manual wheels as a driving mechanism coupled to the back wheels of the chair. The transmission coupling the manual wheels to the back wheels is at the inner side of the wheels (“inner mechanism”). The working parts for folding the chair are occupying the space below the seat.

JP Application No. 2001055863 discloses a non-foldable wheelchair for outdoor travel having manual wheels coupled to the front wheels of the chair (front-wheel-drive mechanism). The transmission is at the outer side of the driving wheels (“outer mechanism”).

U.S. Pat. No. 6,547,265 discloses a transfer wheelchair with no driving mechanism which is used for transferring patients by a caregiver rather than for self-propelling. The chair has removable backrest and armrests and an empty space under the seat enabling positioning directly over the bed for transferring the patient to and off the seat. The seat has an opening with removable closure allowing the patient to stay in the chair while using a pre-existing toilet.

### SUMMARY OF THE INVENTION

In accordance with the present invention, there is provided an indoor wheelchair comprising:

a carriage with a seat having left, right, front and back edges, a backrest, four carrying wheels. (front left, front right, rear left and rear right), and supporting members connecting the seat to the carrying wheels;

a left and a right driving mechanisms mounted to the carriage, each driving mechanism including a manual driving wheel and a transmission connecting the manual driving wheel to one of the respective left and right carrying wheels (traction wheel).

The wheelchair is characterized in that it is free of elements occupying the space under the seat between the innermost surfaces of the driving mechanisms and between the rear carrying wheels so that the wheelchair can be rolled over a common toilet bowl in backward motion, while the overall width of the wheelchair as defined between the outermost surfaces of the driving mechanisms allows passing of the wheel chair through a common bathroom door.

Each driving mechanism comprises a rigid, generally flat member supporting a shaft of the manual driving wheel. This rigid member extends in a substantially vertical plane under the respective left or right edge of the seat. The manual driving wheel is at the outer side of the rigid member while the transmission is at the inner side of the rigid member.

Preferably, the rigid member extends to the traction wheel and supports its shaft, the traction wheel being at the outer side of the rigid member.

The indoor wheelchair further comprises armrests mounted to the carriage and disposed within the overall width. The armrests are preferably configured so that a space remains between them and the backrest, to facilitate operating the manual driving wheel.

Preferably, the driving mechanisms are flush with or below the upper surface of the seat and the armrests are movable to a collapsed state also flush with or below the upper surface of the seat so that a person may leave the seat sideways.

The armrest may have a supporting leg and a tubular basis attached to the carriage, the leg being telescopingly movable in the tubular basis.

The seat of the wheelchair preferably has a central opening with a removable cover allowing use of toilet. The cover may be movable between a horizontal closed position and a vertical open position by pivoting downwards about an axis adjacent the front edge of the seat.

Preferably, the cover has a handle disposed under the front edge of the seat enabling pivoting of the cover while a person is seated in the seat. The cover further may have a locking means for fixing thereof in the closed position.

Preferably, the locking means is formed as a bolt integral with the handle, extending perpendicular to the front edge of the seat under the cover to the back edge of the seat. The handle with the bolt are adapted to slide forward and backward and the seat further has a socket under the back edge adapted to receive the bolt so that when the bolt is in backward position and is received in the socket, the cover is firmly fixed to the seat, and when the bolt is in forward position out of the socket, the cover is free for pivoting by means of the handle.

The transmission of the indoor wheelchair may be encased in a watertight housing. Preferably, the wheelchair is made of water resistant and non-corrosive materials or coatings such that it can be used by a person while taking shower.

The indoor wheelchair may further have brakes operating on either or both front and rear carrying wheels.

In one embodiment, the indoor wheelchair is adapted to be assembled from four modules: the seat, the backrest, and left and right subcarriages, each subcarriage including the respective driving mechanism, carrying wheels and supporting members.

According to another aspect of the present invention, there is provided a driving mechanism for indoor wheelchair, comprising a manual driving wheel with a shaft, a traction wheel with a shaft, a transmission connecting the manual driving wheel to the traction wheel, and a rigid member supporting at least the shaft of the manual driving wheel. The driving mechanism is characterized in that it is configured for mounting to or is integral with one side (left or right) of the wheelchair, with the traction wheel on the floor and the manual driving wheel adjacent the seat of the wheelchair, above the floor; the rigid member is generally flat and extends in a vertical plane at the respective side of the wheelchair; and the transmission is at the inner side of the rigid member with respect to the wheelchair while the manual driving wheel is at the outer side.

Preferably, the traction wheel is a front wheel of the wheelchair.

Preferably, the rigid member extends towards the traction wheel so as to screen the transmission from the outer side. More preferably, the rigid member extends to the traction wheel and supports the shaft of the traction wheel, the traction wheel being at the outer side of the rigid member.

The rigid member may be adapted to be mounted to a horizontal member associated with the seat and to the vertical leg so as to form a rigid triangle therewith.

Preferably, the rigid member is a generally flat shell with ribs. More preferably, the driving mechanism further comprises a generally flat internal cover mountable to the flat shell at the inner side of the transmission so as to form a rigid closed shell.

The rigid closed shell may have sealing elements and may be designed as water-tight housing.

The driving mechanism may be configured so that the wheelchair with two such driving mechanisms mounted thereon will have an overall width defined between the outermost surfaces of the two driving mechanisms, allowing passage of the wheelchair through a common bathroom door.

The driving mechanism may be further configured so that the wheelchair with two such driving mechanisms mounted thereon has also free space under the seat allowing rolling of the wheelchair over a common toilet bowl.

The driving mechanism is preferably configured so that its width defined between the innermost and the outermost surface does not exceed 8 cm.

The driving mechanism may be adapted for mounting and delivery as a module attachable to and detachable from the wheelchair by simple fasteners.

The transmission of the driving mechanism may be or more of the following: chain-and-sprocket transmission, toothed-belt transmission, belt transmission, gear transmission.

The indoor wheelchair of the present invention is highly maneuverable in the layout of a regular home, including bathrooms and toilets. As it travels along level and smooth surfaces, small wheels are used, cutting down the chair's size. The preferable arrangement of front traction wheels with back casters results in a smaller turning radius of the chair.

The chair is of simple, rigid and functional construction, hygienic and washable, and practically mechanically maintenance free.

The chair is safe, and is built so that nothing can be tangled in the driving mechanism.

Separation of the manual drive wheels from the floor traction wheels prevents soiling of the occupant's hands, which soiling happens with the big wheel drive chairs.

The general advantage of the wheelchair of the present invention is that it enables people who cannot use their legs but are otherwise capable to take care of themselves, to move independently even in generally unmodified dwellings, to pass through confined spaces and narrow doorways, and to be able to tend to their needs in the bathroom and toilet independently, even in the absence of a companion.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIGS. 1A, 1B and 1C show respectively side view, front view and top view of an indoor wheel chair according to the present invention;

FIGS. 2A, 2B, 2C and 2D show stages of operation of a toilet cover opening mechanism in the indoor wheel chair of FIG. 1A;

FIGS. 3A and 3B show cross-sections of the driving mechanism of the indoor wheelchair of FIG. 1A through the manual driving wheel and through the traction wheel, respectively;

FIG. 4 shows an embodiment of the indoor wheelchair of the present invention assembled of four modules; and

FIG. 5 shows an embodiment of the indoor wheelchair of the present invention with rear traction wheels.

### DETAILED DESCRIPTION OF THE EMBODIMENTS

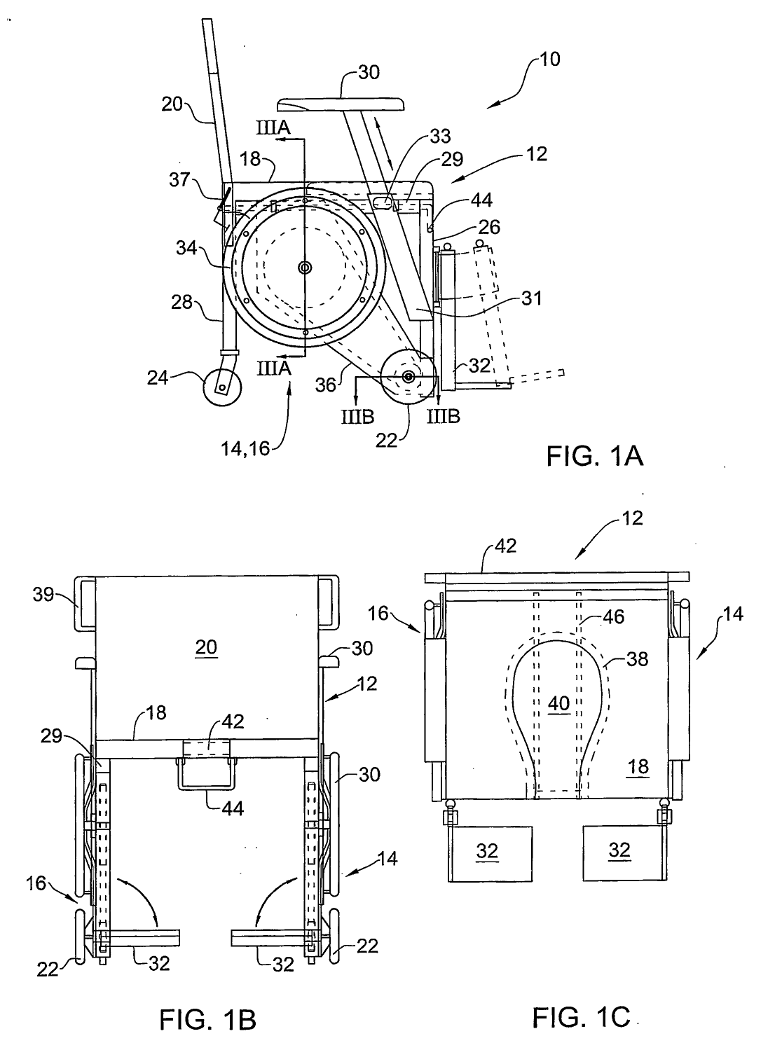

With reference to FIGS. 1A, 1B and 1C, an indoor wheelchair 10 in accordance with the present invention comprises a carriage 12 and a left and a right driving mechanisms 14, 16 mounted to the carriage 12.

The carriage 12 includes a rigid seat 18, a backrest 20, front traction wheels 22, rear caster (turning) wheels 24, legs 26, 28 and other construction members such as beams 29 under the seat 18. The carriage 12 further has collapsible armrests 30 and footrests 32.

Each driving mechanism 14, 16 includes a hand wheel 34 and a transmission 36 coupling the hand wheel 34 to the respective traction wheel 22.

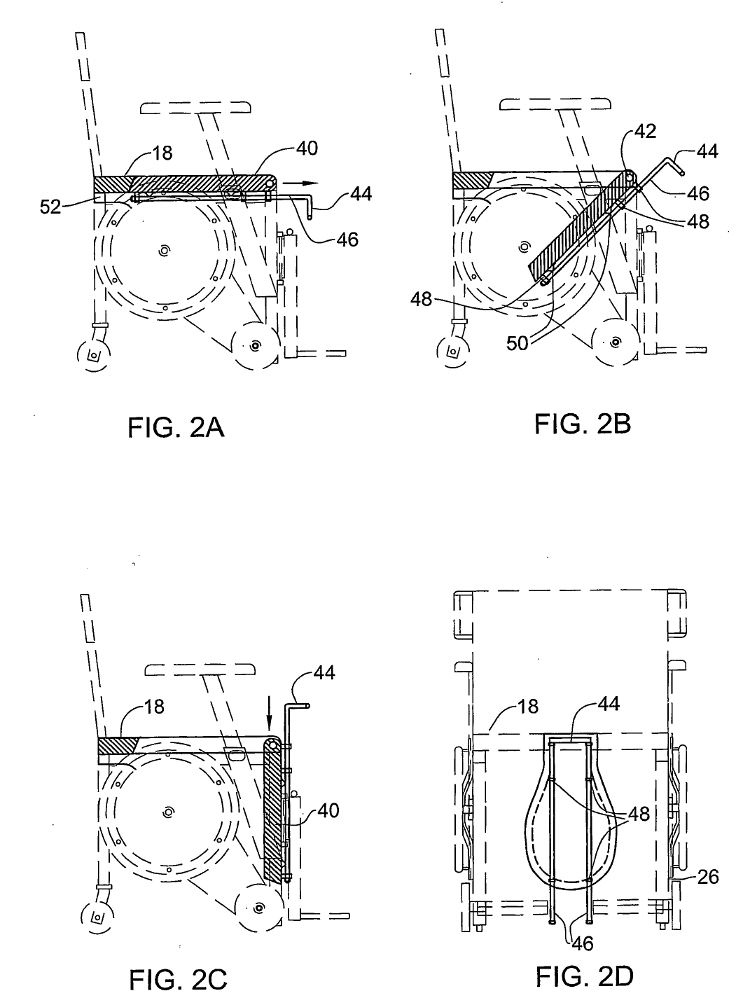

The seat 18 of the wheelchair has a central opening 38 and a movable cover 40 allowing the use of toilet. With reference also to FIG. 2A, the cover 40 is connected to the seat 18 by a hinge 42 with an axis adjacent the front edge of the seat 18. The cover 40 has a handle 44 disposed under the front edge of the seat, which is integral with a dual locking bolt 46. The locking bolt 46 runs under the cover 40 to the back edge of the seat through guides 48. The handle 44 with the bolt 46 can slide in the guides 48 forward and backward but is retained by friction leaf springs 50.

The seat 18 has a socket 52 under its back edge, adapted to receive the bolt 46 so that when the bolt is in backward position and is received in the socket, the cover is firmly fixed to the seat, as best seen in FIGS. 1A and 1C.

The operation of the movable cover is further illustrated in FIGS. 2A-2D. The handle 44 is pulled forward to release the bolt 46 from the socket 52. Then the cover 40 is lowered to vertical position and the wheelchair 10 may be driven over the toilet bowl.

This arrangement enables the removal of the cover, which stays hinged to the chair, even when the occupant sits in the chair and without any need to lift the occupant while removing the cover. The mechanism is operated by the occupant himself, who can open and shut the cover conveniently, while sitting in the chair. He has only to reach between his knees and pull the handle 44 to remove the cover which drops down between front chair legs 26. After that, he can roll the chair backwards over the toilet bowl. In a reverse action, the occupant closes the cover.

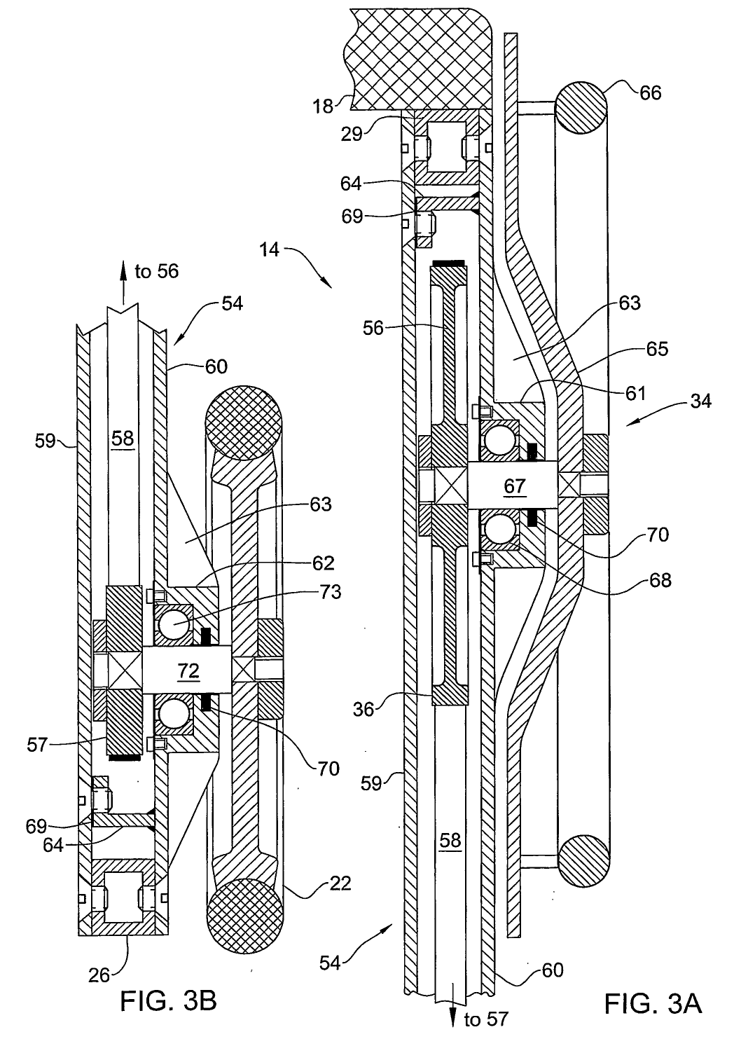

With reference to FIG. 3A, there is shown a partial sectional view of the driving mechanism 14 (or 16) through the axis of the manual driving wheel 34. The driving mechanism further includes a housing 54 accommodating the transmission 36, and the traction wheel 22 (see also FIG. 3B). The transmission 36 comprises one sprocket wheel 56 coupled to the hand wheel 34, a second sprocket wheel 57 coupled to the traction wheel 22, and a chain 58. The housing 54 is a rigid box assembled of two halves 59 and 60 and fixed to the beam 29 under the seat 18, and to the front leg 26.

The outer half 60 is a generally flat shell with sockets 61 and 62, reinforced for rigidity by external ribs 63 and internal ribs 64. The transmission 36 is thus disposed at the inner side of the rigid shell 60 while the hand wheel 34 is at the outer side of the rigid shell (“inner mechanism”). The inner half 59 is a smooth flat sheet which closes the box of the housing enhancing its rigidity.

The hand wheel 34 comprises a disk 65 and a hand ring 66 mounted to the disk. The disk 65 has a dome-shaped central part accommodating the adjacent socket 61 for reduction of the axial dimension of the mechanism. A driving shaft 67 is supported for rotation in a bearing 68 secured in the socket 61. The disk 65 and the sprocket wheel 56 are keyed to the driving shaft 67. The housing 54 is sealed by a gasket 69 and sealing rings 70.

With reference to FIG. 3B, there is shown a partial sectional view of the driving mechanism through the axis of the traction wheel 22. The traction wheel 22 and the sprocket 57 are keyed to a driven shaft 72. The shaft 72 is supported in a bearing 73 secured in the socket 62. The lower end of the housing 54 is fixed to the front leg 26.

The driving mechanisms 14, 16 are designed to be as narrow as possible, to fit under the side edges of the seat 18. This is achieved by the usage of flat carrying members for supporting the shafts of the hand wheel and the traction wheel such as the outer half 60 of the housing 54, rather than tubular or profiled beams. The rigidity of the relatively thin flat member is enhanced by ribs such as 63 and 64, so that it behaves like a 3-D shell. Mounting of the hand wheel outside of the carrying member while the transmission 36 is at the inner side of the carrying member allows reduction of the arms of bending forces acting from the shafts on the carrying member. The same disposition allows the carrying member to screen the transmission from the hand wheel and from entangling foreign objects in general. Thus the carrying member advantageously performs dual function.

Also, the rigidity of the shell-like outer half 60 is enhanced by closing the shell with the inner half 59. Again, the inner half 59 works both as a carrying member and as protective casing under the seat of the wheelchair.

When the housing 54 is assembled to the beam 29 under the seat and to the front leg 26, a very stable triangular structure is obtained. Additionally, the housing may be extended backwards for assembly to the back leg 28, for even greater stability.

Indeed, the driving mechanism may be designed with the hand wheel supported by one member mounted to the beam 29 (or to the seat) and with the traction wheel supported by another member mounted to the leg 26. It is important for the minimal width of the mechanism (see below) that at least the hand wheel with the transmission be mounted in the above-described way (“inner mechanism” on a flat carrying member). The front traction wheel may occupy more space under the seat as far as it is close to the lower front part of the wheelchair. However, the loads acting between the two shafts in the driving mechanism require rigid support which is preferably provided by mounting on one rigid member. The above features allow constructing of a rather slim driving mechanism which may occupy as little as 8 cm between its outermost and innermost surfaces.

The wheelchair is designed to have no elements occupying the space under the seat 18 between the driving mechanisms 14, 16 and between the rear caster wheels. The purpose of this construction is to allow the wheelchair to be positioned over a common toilet bowl while keeping the overall width of the wheelchair minimal, allowing passage through a common bathroom door. Because of the slim design of the driving mechanisms, the wheelchair of FIG. 1 may be rolled over a bowl 42 cm wide while still passing through a door 60 cm wide. Such wheelchair may be used even with a solid seat (without the opening 38) just because of its maneuverability in the confined space of a standard flat.

The water-tight housing assures a long maintenance free life and reliable operation of the transmission drive. Furthermore, the wheelchair can be made of water resistant and non-corrosive materials or coatings such as plastics, aluminum, stainless steel, etc. so that the wheelchair can be used in the shower and can be easily cleaned.

Reverting to FIG. 1A, the armrests 30 are mounted to the carriage 12 such that the overall width of the chair is preserved. The armrests 30 are formed so that a space remains between them and the backrest 20, for easier operating the manual driving wheel.

The collapsible armrests 30 have a supporting leg 29 and a tubular basis 31 attached to the carriage 12. The leg 29 may slide like a telescope into the tubular basis and may be locked in position by a latch 33.

The manual driving wheel 34 is somewhat lower than the seat 18 so that the armrests 30 may be collapsed flush with the upper surface of the seat. This enables the occupant to leave the wheel chair sideways, i.e. to move to a bed without obstruction.

The wheelchair 10 has other accessories known per se in the art: brakes 37 operating on the hand wheel 34 and companion handles 39. All accessories are designed with a view to preserve the overall width of the wheelchair and to keep the length smaller.

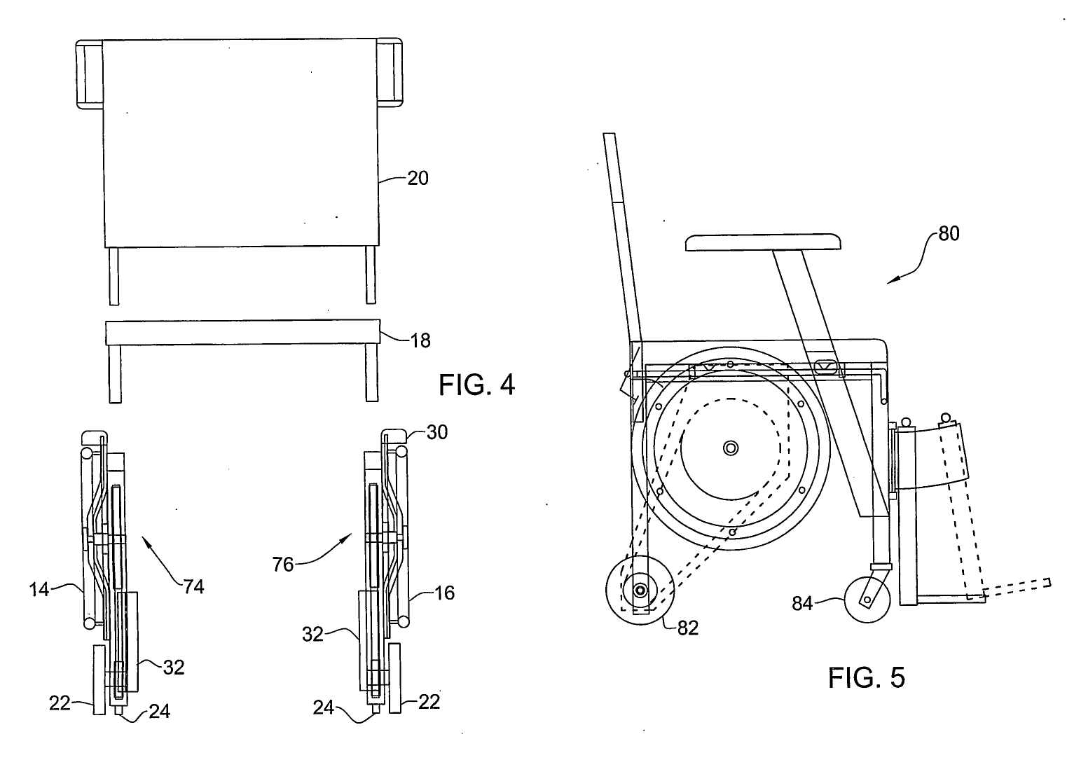

As shown in FIG. 4, the wheelchair of the present invention can be produced for easier delivery and assembly from four modules: the seat 18, the backrest 20, and left and right subcarriages 74 and 76. Each subcarriage includes the respective driving mechanisms 14 and 16, carrying wheels 22 and 24, legs 26 and 28, and other members of the carriage 12.

FIG. 5 shows an embodiment of the wheelchair 80 with rear traction wheels 82 and front caster wheels 84. The advantage of this chair is better maneuverability in traveling backwards. However, for overall use, the front drive design seems superior.

The proposed wheelchair can be manufactured in various seat widths by changing only seat and backrest, most applicable seat width being “Adult” which is about 48 cm or even “Large” 52 cm. Yet the designed overall wheelchair width will be narrower than regular wheelchairs with same seats. This is a necessary condition for practical home use.

As pointed out already, one of the objects of this invention is a wheelchair with minimal outside dimensions, to enable free movement in standard sized dwellings. This is achieved by sophisticated design, which at the same time does not constrict the regular occupant's seat dimensions. Also maximum clear space is provided beneath the seat to allow the mounting of any regular toilet bowl.

More specific, in common manual wheel chair, the overall chair width is 15 to 21 cm more than the seat width. In contrast, in the design of the present invention, the indoor wheelchair can be only about 8 cm wider than the seat. This makes a crucial difference in the ability to pass through doorways, especially those of bathrooms. At the same time, the internal side of the drive mechanisms, i.e. the chain (or belt) drives are in line with the chair's legs profiles, taking altogether only about 7 cm off the space beneath the seat. This leaves ample space under the seat to drive over any regular toilet bowl.

The absence of large rear driving wheels also shortens the length of the wheelchair by 15 to 20 cm, adding to the chair's maneuverability.

Thus, the smaller outer dimensions together with the front drive make the proposed wheelchair highly maneuverable for indoor use.

Although a description of specific embodiments has been presented, it is contemplated that various changes could be made without deviating from the scope of the present invention. For example, the movable cover may have a different locking mechanism; the driving mechanism may be not encased in water-tight housing (though guards should be provided); the brake system may operate also on the caster wheels, etc.

1. An indoor wheelchair comprising:
a carriage with a seat having left, right, front and back edges, a backrest, four carrying wheels (front left, front right, rear left and rear right), and supporting members connecting said seat to said carrying wheels;
a left and a right driving mechanisms mounted to said carriage, each driving mechanism including a manual driving wheel and a transmission connecting said manual driving wheel to one of the respective left and right carrying wheels (traction wheel), and having width defined between innermost and outermost surfaces of said driving mechanism, wherein
said wheelchair is free of elements occupying the space under said seat between said innermost surfaces of the driving-mechanisms and between the rear carrying wheels so that said wheelchair can be rolled over a common toilet bowl in backward motion; and
the overall width of said wheelchair as defined between said outermost surfaces of the driving mechanisms allows passing of the wheel chair through a common bathroom door.

2. The indoor wheelchair of claim 1, wherein each of said driving mechanisms further comprises a rigid, generally flat member supporting a shaft of said manual driving wheel, said member extending in a substantially vertical plane under the respective left or right edge of said seat, said manual driving wheel being at the outer side of said rigid member and said transmission being at the inner side of said rigid member.

3. The indoor wheelchair of claim 2, wherein said rigid member extends to said traction wheel and supports a shaft of said traction wheel, said traction wheel being at the outer side of said rigid member.

4. The indoor wheelchair of claim 1, further comprising armrests mounted to said carriage and disposed within said overall width.

5. The indoor wheelchair of claim 4, wherein said armrests are configured so that a space remains between them and said backrest, said space facilitating operating the manual driving wheel.

6. The indoor wheelchair of claim 4, wherein said driving mechanisms are flush with or below the upper surface of said seat and said armrests are movable to a collapsed state flush with or below the upper surface of said seat so that a person may leave said seat sideways.

7. The indoor wheelchair of claim 6, wherein said armrests have each a supporting leg and a tubular basis attached to said carriage, said leg being telescopingly movable in said tubular basis.

8. The indoor wheelchair of claim 1, wherein said seat has a central opening with a removable cover allowing use of toilet.

9. The indoor wheelchair of claim 8, wherein said cover is movable between a horizontal closed position and a vertical open position by pivoting downwards about an axis adjacent the front edge of said seat.

10. The indoor wheelchair of claim 9, wherein said cover has a handle disposed under said front edge of said seat enabling pivoting of said cover while a person is seated in said seat.

11. The indoor wheelchair of claim 10, wherein said cover further has a locking means for fixing thereof in said closed position.

12. The indoor wheelchair of claim 11, wherein said locking means is formed as a bolt integral with said handle, said bolt extending perpendicular to said front edge of the seat under said cover to the back edge of the seat, said handle with said bolt being adapted to slide forward and backward, said seat further having a socket under said back edge adapted to receive said bolt so that when said bolt is in backward position and is received in said socket said cover is firmly fixed to said seat, and when said bolt is in forward position out of said socket, said cover is free for pivoting by means of said handle.

13. The indoor wheelchair of claim 1, wherein said transmission is encased in a watertight housing.

14. The indoor wheelchair of claim 13, wherein said wheelchair is made of water resistant and non-corrosive materials or coatings such that said wheelchair can be used by a person while taking shower.

15. The indoor wheelchair of claim 1, further having brakes operating on either or both front and rear carrying wheels.

16. The indoor wheelchair of claim 1, wherein said wheelchair is adapted to be assembled from four modules: said seat, said backrest, and left and right subcarriages, each subcarriage including the respective driving mechanism, carrying wheels and supporting members.

17. A driving mechanism for indoor wheelchair, comprising a manual driving wheel with a shaft, a traction wheel with a shaft, a transmission connecting said manual driving wheel to said traction wheel and a rigid member supporting at least the shaft of the manual driving wheel, wherein
said driving mechanism is configured for mounting to or is integral with left or right side of said wheelchair, with said traction wheel on the floor and said manual driving wheel adjacent the seat of said wheelchair, above the floor;
said rigid member is generally flat and extends in a vertical plane at the respective side of said wheelchair; and
said transmission is at the inner side of said rigid member with respect to said wheelchair while said manual driving wheel is at the outer side.

18. The driving mechanism of claim 17, wherein said rigid member extends towards said traction wheel so as to screen said transmission from the outer side thereof.

19. The driving mechanism of claim 18, wherein said rigid member extends to said traction wheel and supports said shaft of the traction wheel, the traction wheel being at the outer side of said rigid member.

20. The driving mechanism of claim 19, wherein said wheelchair has a generally horizontal member associated with said seat and a generally vertical leg, and said rigid member is adapted to be mounted to said horizontal member and to said vertical leg so as to form a rigid triangle therewith.

21. The driving mechanism of claim 19, wherein said rigid member is a generally flat shell with ribs.

22. The driving mechanism of claim 21, further comprising a generally flat internal cover mountable to said flat shell at the inner side of said transmission so as to form a rigid closed shell.

23. The driving mechanism of claim 22, wherein said rigid closed shell has sealing elements and is designed as water-tight housing.

24. The driving mechanism of claim 17, wherein said driving mechanism has an innermost surface and an outermost surface with respect to said wheelchair and is configured so that said wheelchair with two such driving mechanisms mounted thereon has an overall width defined between the outermost surfaces of the two driving mechanisms, said overall width allowing passage of said wheelchair through a common bathroom door.

25. The driving mechanism of claim 24, wherein said driving mechanism is configured so that said wheelchair with two such driving mechanisms mounted thereon has free space under said seat defined between the innermost surfaces of said driving mechanisms, said free space allowing rolling of said wheelchair over a common toilet bowl.

26. The driving mechanism of claim 17, wherein said driving mechanism has an innermost surface and an outermost surface with respect to said wheelchair and is configured so that a width of said driving mechanism defined between said innermost and said outermost surface does not exceed 8 cm.

27. The driving mechanism of claim 17, wherein said transmission is one or more of the following: chain-and-sprocket transmission, toothed-belt transmission, belt transmission, gear transmission.

28. The driving mechanism of claim 17, wherein said mechanism is adapted for mounting and delivery as a module attachable to and detachable from said wheelchair by simple fastening means.

29. The driving mechanism of claim 17, wherein said traction wheel is a front wheel of said wheelchair.
